(19) United States
(12) Patent Application Publication
(10) Pub. No.: US 2025/0387209 A1
(43) Pub. Date: Dec. 25, 2025

(54) APPARATUS FOR CLEANING DENTAL IMPLANTS

(71) Applicants: Jimmy Wagner, Brooklyn, NY (US); Vincent Settecase, Brooklyn, NY (US)

(72) Inventors: Jimmy Wagner, Brooklyn, NY (US); Vincent Settecase, Brooklyn, NY (US)

(21) Appl. No.: 19/238,248

(22) Filed: Jun. 13, 2025

Related U.S. Application Data
(60) Provisional application No. 63/663,680, filed on Jun. 24, 2024.

(51) Int. Cl. A61C 17/02

(52) U.S. Cl. CPC A61C 17/0202

(57) ABSTRACT

An apparatus for cleaning dental implants is disclosed. The apparatus comprises a refillable tank configured to hold a cleaning fluid such as saline, a compressor or pump operably coupled to the tank to generate a pressurized stream, and a hand-held gun member that directs the fluid for cleaning. The apparatus further includes a foot-operated control system that allows an operator to activate and, in some embodiments, modulate the pressure of the fluid stream. The gun member may include a replaceable or disposable tip for hygienic application and an emergency shut-off mechanism to prevent accidental injury. The system is designed to clean implant surfaces effectively while avoiding damage to protective coatings or surrounding tissues, making it suitable for use in clinical or professional dental environments

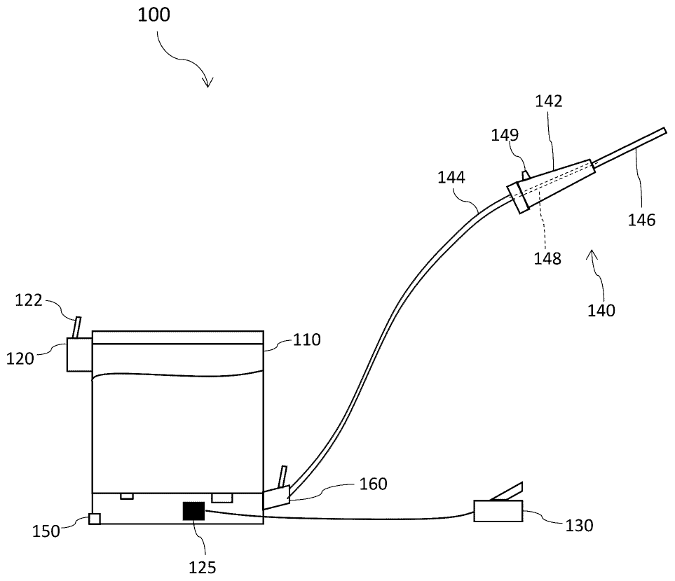

### CROSS REFERENCE TO RELATED APPLICATIONS

This application claims priority from a U.S. Provisional Patent Appl. No. 63/663,680, filed on Jun. 24, 2024, which is incorporated herein by reference in its entirety.

### FIELD OF INVENTION

The present invention relates to dental hygiene, and more particularly, the present invention relates to an apparatus for cleaning dental implants.

### BACKGROUND

Dental picks are commonly used to remove plaque, calculus, and other deposits from teeth. These instruments typically feature a rigid structure with a pointed or angled tip designed to access and dislodge debris from the tooth surface, between teeth, and along the gumline. While effective, dental picks must be used with care, as improper use can damage tooth enamel or injure gum tissue. When used on dental implants, dental picks—particularly those made of soft steel—can cause unintended harm. Specifically, they may scrape or erode the protective oxide layer on titanium or other metals used in implants, leading to irritation, inflammation, and potential long-term bone degradation.

Accordingly, there is a recognized need for an improved cleaning method specifically designed for dental implants—one that ensures effective removal of debris without compromising the integrity of the implant surface or surrounding tissues.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to an apparatus for cleaning the dental implants in a clinical setting that is safe and effective.

Another object of the present invention is that the apparatus is easy to use.

Still another object of the present invention is that the apparatus is economical to manufacture.

### BRIEF DESCRIPTION OF DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

The drawing illustrates the apparatus, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an”, and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention, since the scope of the invention will be best defined by the allowed claims of any resulting patent.

The present invention relates to an apparatus designed for the safe and effective cleaning of dental implants. The apparatus comprises a saline water pick that delivers pressurized saline to remove debris from implant surfaces without causing damage to the protective coating typically found on metal implants, such as titanium. This design minimizes the risk of irritation or long-term degradation at the implant site and supports the preservation of the biological interface between the implant and surrounding bone. The apparatus is particularly well-suited for use in clinical settings, offering a user-friendly, efficient, and hygienic cleaning solution. Disposable components may be incorporated to prevent cross-contamination between patients. Furthermore, the apparatus can be adapted for use at various scales to accommodate different clinical or personal care environments.

The apparatus may be operated via a foot pedal, allowing for hands-free control and improving ease of use during the cleaning procedure. Following each use, disposable components can be quickly and efficiently replaced, thereby reducing downtime and minimizing the effort required for maintenance. To enhance user safety, the apparatus is further equipped with an emergency shut-off mechanism designed to immediately halt operation and prevent potential injury.

Referring to the drawing, the apparatus 100 includes a tank 110 configured to hold saline water. The tank capacity may vary depending on the intended application or clinical setting. It may be constructed from any suitable material, such as metal or plastic, and is designed to be refillable as needed. In some embodiments, the tank is removably attached to the housing of the apparatus to facilitate cleaning and sterilization. It is understood that the tank may be filled with any appropriate fluid suitable for dental cleaning, including solutions containing additives or disinfectants to enhance the cleaning process.

The assembly may also include a compressor or a pump, for creating a pressurized stream of saline water. The drawing shows the compressor 120 operably coupled to the tank 110. The compressor includes a hard button 122 to turn the compressor on and off. The apparatus 100 further includes a foot pedal 130 that is operably coupled to the compressor 120 or a controller 125 of the apparatus 100. The pressure generated by the compressor 120 can be controlled using the foot pedal 130. Also, the compressor 120 can be turned on and off using the foot pedal. The foot pedal can be operated by the foot of the operator. The term operator herein and throughout the disclosure refers to a person operating the apparatus. In certain implementations, the foot pedal may be for just turning the compressor on and off, and the pressure can be adjusted by any other means. In certain implementations, the foot pedal may have an option to adjust the pressure. For example, a knob can be provided in the foot pedal for increasing or decreasing the pressure. Also, the pedal itself may have a pressure sensor that can sense the force exerted by the foot of the operator and accordingly adjust the pressure.

The force exerted on the pedal may be increased to increase the pressure of the saline stream. As a safeguard, the pressure sensor may also process a gradual increase in the pressure. Any sudden or abrupt force on the pedal may be accidental and could be ignored by the pressure sensor. Also, removing the foot from the foot pedal may cause the compressor to stop immediately. The apparatus may further include a handheld gun member 140 that allows directing a stream of saline water under pressure. The gun member 140 may include a handle 142 for holding the gun member 140 in hand. The handle may be of an elongated profile having a proximal end and a distal end. The handle may be designed ergonomically so that the gun member can be maneuvered by hand for cleaning the dental implant safely and efficiently. To the proximal end of the handle may be mounted a tube 144, further connecting to the tank. To the distal end of the handle may be mounted a pick 146, wherein the tube and the pick may be fluidly coupled through channel 148 passing through the handle. The pick is designed to create a fine stream of saline that can be directed to an object under high pressure.

The handle may also include an emergency shut-off button 149 that can cut the supply of fluid to the pick through the channel. For example, said button 149 can interrupt channel 148, preventing the flow of liquid. The compressor, upon detecting counterforce due to the stoppage of flow, can automatically stop.

The pick 146 may be interchangeably coupled to the channel. Perhaps the pick may be disposable and could be replaced by a new one. In certain implementations, the whole gun member 140 may be disposable and could be replaced by a new one.

In certain implementations, the tank 110 may include a drain valve 150 for emptying the tank. This drain valve may be provided at the bottom of the tank so that the tank can be completely drained. For example, the tank can be emptied for cleaning and refilled with new saline. The tank may also have a cut-off valve 160 to control the flow of saline from the tank to the tube.

In operation, the apparatus may be used by an operator, such as a dentist or a dental assistant, to clean dental implants safely and effectively. The pressurized stream of saline produced by the apparatus is capable of dislodging and removing debris from the surface of the implant without causing physical damage. Unlike traditional cleaning methods that rely on metal instruments and may compromise the protective coating on metal implants, the disclosed apparatus eliminates the risk of metal-on-metal contact. This system offers professional-grade cleaning performance while preserving the integrity of the implant surface, thereby representing a significant advancement in dental implant maintenance.

While the foregoing description enables those skilled in the art to make and use what is presently considered to be the best mode of the invention, it will be understood and appreciated that various modifications, substitutions, combinations, and equivalents of the described embodiments, methods, and examples may be made without departing from the scope of the invention. Accordingly, the invention should not be limited to the specific embodiments, methods, or examples described above, but should be interpreted in accordance with the full scope and spirit of the claims appended hereto.

What is claimed is:

1. An apparatus for cleaning dental implants, the apparatus comprising:
a tank configured to hold a cleaning fluid;
a gun member comprising:
a handle of an elongated and ergonomic profile;
a channel longitudinally passing through the handle; and
a pick coupled to a distal end of the channel, wherein the pick is configured to generate a fine stream of the cleaning fluid; and
a tube coupled to a proximal end of the channel, wherein the tube is fluidly coupled to the tank.

2. The apparatus of claim 1, wherein the apparatus further comprises:
a compressor operably coupled to the tank and configured to generate a pressurized stream of the cleaning fluid.

3. The apparatus of claim 2, wherein the apparatus further comprises:
a foot pedal operably coupled to the compressor; the foot pedal configured to regulate activation of the compressor.

4. The apparatus of claim 3, wherein the foot pedal comprises a pressure sensor configured to modulate the pressure of the stream of the cleaning fluid based on a force applied by an operator's foot.

5. The apparatus of claim 4, wherein the cleaning fluid comprises saline water.

6. A method for cleaning a dental implant, comprising:
providing an apparatus comprising:
a tank configured to hold a cleaning fluid,
a gun member comprising:
a handle having an elongated and ergonomic profile,
a channel longitudinally passing through the handle, and
a pick coupled to a distal end of the channel, wherein the pick is configured to generate a fine stream of the cleaning fluid, and
a tube coupled to a proximal end of the channel, wherein the tube is fluidly coupled to the tank;
operating a foot pedal to activate a compressor to pressurize and direct the cleaning fluid through the gun member; and
directing the pressurized stream of the cleaning fluid from the gun member onto a surface of the dental implant to dislodge and remove debris without damaging a protective coating of the dental implant.

7. The method of claim 6, wherein the foot pedal is operably coupled to the compressor or a controller of the apparatus, wherein the method further comprises:
adjusting the pressure of the stream of the cleaning fluid via the foot pedal.

8. The method of claim 7, wherein the pick is removably and interchangeably coupled to the channel.
